(19) United States
(12) Patent Application Publication
(10) Pub. No.: US 2023/0198027 A1
(43) Pub. Date: Jun. 22, 2023

(54) METAL SULFATE SYSTEMS FOR LEAD-ACID BATTERIES

(71) Applicant: Daramic, LLC, Charlotte, NC (US)

(72) Inventors: Kumar Manickam, Gujarat (IN); J. Kevin Whear, Utica, KY (US); Margaret R. Roberts, Owensboro, KY (US)

(21) Appl. No.: 17/923,214

(22) PCT Filed: May 4, 2021
(86) PCT No.: PCT/US2021/030538

§ 371 Date: Nov. 3, 2022

Related U.S. Application Data
(60) Provisional application No. 63/019,682, filed on May 4, 2020.

(51) Int. Cl. H01M 10/08; H01M 10/12; H01M 50/431

(52) U.S. Cl. CPC H01M 10/08; H01M 10/12; H01M 50/431; H01M 2220/20

(57) ABSTRACT

A lead acid battery is disclosed comprising a positive electrode; a negative electrode; a separator; and an electrolyte comprising a metal sulfate; wherein lead sulfate crystals formed during cycling of the lead acid battery have an average diameter in one dimension of less than 1.1 microns, less than 1.0 microns, less than 0.95 microns, or less than 0.9 microns.

### CROSS REFERENCE TO RELATED APPLICATIONS

This application is a 371 U.S. application claiming priority to PCT/US2021/030538 filed May 4, 2021, which claims priority to U.S. Provisional Patent Application Ser. No. 63/019,682, filed May 4, 2020, which is hereby fully incorporated by reference herein.

### FIELD

In at least select embodiments, the instant disclosure or invention is directed to new or improved battery separators, battery electrolytes, components, materials, lead acid batteries, systems, and/or related methods of production and/or use. In at least certain embodiments, the instant disclosure or invention is directed to additives for use in a lead acid battery; additives for use in an electrolyte in a lead acid battery; additives for use with a battery separator in a lead acid battery; to battery separators with an additive; and/or to batteries including such separators; and/or to products, devices or vehicles including such batteries. In at least certain select embodiments, the instant disclosure relates to new or improved lead acid batteries and/or systems and/or vehicles having reduced lead sulfate crystal sizes and/or methods of manufacture and/or use thereof. In at least select embodiments, the instant disclosure is directed toward a new or improved lead acid battery, lead acid battery separator, or system with additives that reduce lead sulfate crystal sizes; toward a new or improved lead acid battery, lead acid battery separator, system with additives that improve charge acceptance of a lead acid battery, or battery electrolyte additives; toward a new or improved lead acid battery, lead acid battery separator, electrolyte additives, or system with additives that reduce hydrogen gassing and/or reduce peak current density in a lead acid battery; and/or towards methods for constructing new or improved lead acid batteries, and lead acid battery separators with such additives.

### BACKGROUND

Lead acid batteries are ubiquitous in modern society, powering everything from automobiles to lawn mowers to construction equipment. While the structural components of lead acid batteries have changed dramatically over many decades, the basic chemistry remains the same. Coincidentally, the most common reason for battery failure is related to the failure of the battery to perform this basic chemistry.

During battery discharge, portions of the materials comprising the cathode and anode are converted to PbSO₄ crystals. By applying an opposite voltage, a reverse chemical reaction can be performed that converts the PbSO₄ back into Pb(s) (anode) and PbO₂(s) (cathode). The average size of the PbSO₄ crystals is important. If the crystals are small, then the overall surface area of the crystals is large, facilitating the complete conversion of PbSO₄ back into Pb(s) and PbO₂(s), However, larger PbSO₄ crystals have a smaller overall surface area, slowing the conversion process. Unfortunately these larger crystals often do not completely convert back into Pb(s) and PbO₂(s), leading to agglomeration and fusing together of the lead sulfate crystals to ultimately form a highly insoluble lead sulfate sediment. This sulfate sediment slowly builds an inert, passive layer on the electrodes, and often flakes off the electrodes to eventually cause short circuiting of the cell or self-discharge.

Accordingly, batteries that form small PbSO₄ crystals during discharge would be beneficial in extending the life of the battery.

### SUMMARY

In an aspect, a lead acid battery comprises a positive electrode; a negative electrode; a separator; and an electrolyte comprising a metal sulfate other than lead sulfate; wherein lead sulfate crystals formed during cycling of the lead acid battery have an average diameter in one dimension of less than 1.1 microns, less than 1.0 microns, less than 0.95 microns, or less than 0.9 microns. In some embodiments, lead sulfate crystals formed during cycling of the lead acid battery have an average diameter in one dimension of 0.4 microns to 0.9 microns.

In some embodiments, the metal sulfate other than lead sulfate comprises, consists essentially of, or consists of aluminum sulfate, zinc sulfate, potassium sulfate, sodium sulfate, lithium sulfate, or nickel sulfate. The metal sulfate can be present in the electrolyte, and in some cases can be present in the electrolyte at a concentration of 1% or less. In some instances, a peak current density of a lead acid battery described herein is at least 20% lower than a lead acid battery having an electrolyte without a metal sulfate other than lead sulfate present. In some cases, a hydrogen gassing current at −1.4V for a lead acid battery described herein is at least 70% lower than a lead acid battery having an electrolyte without a metal sulfate present.

In some embodiments, a separator described herein comprises the metal sulfate. The metal sulfate is coated on the separator in some instances. In some cases the metal sulfate is coated on the separator in an amount of 1 g/sqm to 4.0 g/sqm. However, any amount on the separator may be acceptable as long as an appropriate amount of metal sulfate ends up in the electrolyte. The metal sulfate can be roller coated, immersion coated, spray coated on the separator, or any combination thereof. In some cases the separator is made of a microporous material.

In some embodiments, the separator may comprise ribs on at least one face thereof. The ribs may be continuous, discontinuous, serrated, embattlemented, and the like. In some embodiments, the separator may have ribs like those of the RipTide™ separator sold by Daramic LLC. In some preferred embodiments, the separator may comprise ribs and the ribs may be arranged in an acid-mixing profile. For example, the ribs may be discontinuous, serrated, embattlemented, or the like. The rib profile of the RipTide™ separator sold by Daramic LLC is one example of a possibly preferred acid-mixing profile. Without wishing to be bound by any particular theory, it is believed that using a separator with an acid-mixing rib profile may aid in release of the metal sulfate into the electrolyte in embodiments where the metal sulfate is coated onto a separator. An acid-mixing profile may also aid in dispersing the metal sulfate in the electrolyte.

In some embodiments, at least one of a battery separator, a glass mat, a woven, a nonwoven, a gauntlet, a pasting paper, the negative electrode, the positive electrode, or combinations thereof may comprise a metal sulfate as described herein. The metal sulfate may be present on the separator glass mat, a woven, a nonwoven, a gauntlet, a pasting paper, negative electrode, positive electrode, or any combination thereof in an amount such that when the glass mat, a woven, a nonwoven, a gauntlet, a pasting paper, negative electrode, positive electrode, or any combination thereof are used in a battery, the appropriate amount of metal sulfate is released into and/or ends up in the electrolyte by release or any other means. In some embodiments, the metal sulfate is present in an amount of 1 g/sqm to 4.0 g/sqm on the separator glass mat, a woven, a nonwoven, a gauntlet, a pasting paper, negative electrode, positive electrode, or any combination thereof. The metal sulfate can be roller coated, immersion coated, spray coated onto the separator, glass mat, a woven, a nonwoven, a gauntlet, a pasting paper, negative electrode, positive electrode, or any combination thereof.

In some embodiments, a vehicle comprises any lead acid battery described herein.

In another aspect, a method of reducing the size of lead sulfate crystals in a lead acid battery during cycling comprises adding a metal sulfate other than lead sulfate to an electrolyte solution in the lead acid battery, wherein lead sulfate crystals formed during cycling of the lead acid battery have an average diameter in one dimension less than 1.1 microns, less than 1.0 microns, less than 0.95 microns, or less than 0.9 microns. In some cases, lead sulfate crystals formed during cycling of the lead acid battery have an average diameter in one dimension that is at least 60% smaller than lead sulfate crystals formed during cycling of a lead acid battery without a metal sulfate other than lead sulfate present. In some instances, the electrolyte solution comprises a concentration of 1% or less of metal sulfate other than lead sulfate.

In an aspect, a method of reducing the size of lead sulfate crystals in a lead acid battery during cycling comprises forming a battery separator comprising a metal sulfate other than lead sulfate; and placing the coated battery separator into a lead acid battery, wherein the lead sulfate crystals formed during cycling of the lead acid battery have an average diameter in one dimension less than 1.0 microns, less than 0.95 microns, or less than 0.9 microns. In some embodiments, the metal sulfate other than lead sulfate is coated within pores on a surface of the separator, on a surface of the separator, or both. The method for providing the metal sulfate other than lead sulfate comprises in some instances, roller coating, immersion coating, or spray coating a composition comprising the metal sulfate other than lead sulfate on the separator. In some embodiments, lead sulfate crystals formed during cycling of the lead acid battery have an average diameter in one dimension that is at least 60% smaller than lead sulfate crystals formed during cycling of a lead acid battery without a metal sulfate present.

In another aspect, a battery separator, glass mat, a woven, a nonwoven, a gauntlet, a pasting paper, or electrode comprising a metal sulfate is disclosed herein. The metal sulfate may be at least one selected from aluminum sulfate, zinc sulfate, potassium sulfate, sodium sulfate, lithium sulfate, magnesium sulfate, barium sulfate, nickel sulfate, or combinations thereof.

### BRIEF DESCRIPTION OF THE DRAWINGS

FIG. 1A, FIG. 1B, FIG. 1C, FIG. 1D, and FIG. 1E show scanning electron microscopy images of lead sulfate crystals formed in the presence of electrolyte having 0%, 0.25%, 0.5%, 0.85%, and 1.7%, respectively, of zinc sulfate.

FIG. 2A, FIG. 2B, FIG. 2C, FIG. 2D, and FIG. 2E show scanning electron microscopy images of lead sulfate crystals formed in the presence of electrolyte having 0%, 0.25%, 0.5%, 0.85%, and 1.7%, respectively, of aluminum sulfate.

FIG. 3A and FIG. 3B are reproductions of portions of FIGS. 2D and 2E, and graphically highlight tree-like dendrite formations.

FIG. 4 is an illustration of metal sulfate nucleation mediated lead sulfate crystal formation.

FIG. 5 is a chemical schematic showing a proposed chemical process of an acid gravity increase and lead sulfate formation in the presence of different metal sulfates.

FIG. 6 is a graphical representation showing lead sulfate solubility at different concentrations of metal sulfate.

FIG. 7 shows data for embodiments described herein including different coating weights of aluminum sulfate (AS) compared to a control containing no aluminum sulfate (AS).

FIG. 8 shows data for embodiments described herein including different coating weights of aluminum sulfate (AS) compared to a control containing no aluminum sulfate (AS).

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, such as 1.0 to 5.3, or 4.7 to 10.0, or 3.6 to 7.9.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

In at least select embodiments, the instant disclosure or invention is directed to new or improved battery separators, battery electrolytes, components, materials, lead acid batteries, systems, and/or related methods of production and/or use. In at least certain embodiments, the instant disclosure or invention is directed to additives for use in a lead acid battery; additives for use in an electrolyte in a lead acid battery; additives for use with a battery separator in a lead acid battery; to battery separators with an additive; and/or to batteries including such separators; and/or to products, devices or vehicles including such batteries. In at least certain select embodiments, the instant disclosure relates to new or improved lead acid batteries and/or systems and/or vehicles having reduced lead sulfate crystal sizes and/or methods of manufacture and/or use thereof. In at least select embodiments, the instant disclosure is directed toward a new or improved lead acid battery, lead acid battery separator, or system with additives that reduce lead sulfate crystal sizes; toward a new or improved lead acid battery, lead acid battery separator, system with additives that improve charge acceptance of a lead acid battery, or battery electrolyte additives; toward a new or improved lead acid battery, lead acid battery separator, electrolyte additives, or system with additives that reduce hydrogen gassing and/or reduce peak current density in a lead acid battery; and/or towards methods for constructing new or improved lead acid batteries, and lead acid battery separators with such additives.

### I. Batteries

In an aspect, a lead acid battery (“battery”) is described herein. The battery can be any lead acid battery not inconsistent with the objectives of this disclosure, such as a flooded lead acid battery, valve regulated lead acid (VRLA), enhanced flooded battery (EFB), and the like. In some preferred embodiments, the battery may be one that operates at a partial state of charge.

Generally, a battery described herein comprises a positive electrode; a negative electrode; a separator; and an electrolyte. The separator is positioned between the negative and positive electrodes, and the electrolyte is in contact with, or in communication with, both the negative and positive electrodes, and the separator. The negative and positive electrodes can be made of any material known in the art for lead acid battery electrodes. The separator can also be made of any material known in the art for lead acid battery separators. In some embodiments, the separator is made of a microporous material such as a porous polyolefin, nylon, polyvinyl chloride, cellulose, glass, natural or synthetic nonwoven fibers, or other known materials. In some particular embodiments, the separator can be any separator material manufactured by Daramic® LLC, Charlotte, N.C.

An electrolyte described herein can comprise any electrolyte composition known in the art for lead acid battery that is not inconsistent with the objectives of this disclosure. For example, in some instances, the electrolyte is an aqueous acid, such as sulfuric acid. In some embodiments, the electrolyte comprises a metal sulfate additive. The metal sulfate additive can be aluminum sulfate, zinc sulfate, potassium sulfate, sodium sulfate, lithium sulfate, magnesium sulfate, barium sulfate, or nickel sulfate. In some embodiments, the metal sulfate additive consists essentially of or consists of one metal sulfate. In other embodiments, the metal sulfate additive comprises, consists essentially of, or consists of one, two, or more metal sulfates. In some embodiments, the metal sulfate additive consists or consists essentially of at least one selected from the group consisting of aluminum sulfate, zinc sulfate, potassium sulfate, sodium sulfate, lithium sulfate, nickel sulfate, magnesium sulfate, barium sulfate, or combinations thereof. In some embodiments, the metal sulfate additive consists of one selected from the group consisting of aluminum sulfate, zinc sulfate, potassium sulfate, sodium sulfate, lithium sulfate, magnesium sulfate, barium sulfate, and nickel sulfate.

In some preferred embodiments, the metal sulfate is released into the electrolyte from a separator, glass mat, a woven, a nonwoven, a gauntlet, a pasting paper, an electrode, or any combination thereof that comprises the metal sulfate. Some metal sulfate may remain on the separator, glass mat, a woven, a nonwoven, a gauntlet, a pasting paper, or electrode, and some released into the electrolyte of the battery from the separator, glass mat, a woven, a nonwoven, a gauntlet, a pasting paper, electrode, or some combination thereof. In some other embodiments, the metal sulfate may be added directly to the electrolyte, for example, by adding a tablet comprising the metal sulfate to the electrolyte. In some embodiments, the metal sulfate may be released into the electrolyte from a separator, glass mat a woven, a nonwoven, a gauntlet, a pasting paper, an electrode, or any combination thereof and also added, for example, via a tablet comprising the zinc sulfate.

In some embodiments, addition of the metal sulfate additive to the electrolyte can reduce a size of lead sulfate crystals formed during cycling of a battery, increase a charge acceptance of a battery, decrease peak current density of a battery, and/or reduce hydrogen gassing of a battery described herein compared to a battery having an electrolyte without a metal sulfate additive.

In some embodiments, lead sulfate crystals formed during cycling of the lead acid battery described herein have an average diameter in one dimension of 1.0 micron or less, 0.95 microns or less, 0.9 microns or less, 0.85 microns or less, 0.8 microns or less, 0.75 microns or less, 0.7 microns or less, 0.65 microns or less, 0.6 microns or less, 0.55 microns or less, or 0.5 microns or less when a metal sulfate additive is present in the electrolyte. In some instances, lead sulfate crystals formed during cycling of the lead acid battery in an electrolyte having a metal sulfate additive has an average diameter in one dimension of 0.3 microns to 1 microns, 0.4 microns to 0.9 microns, 0.4 microns to 0.8 microns, 0.4 microns to 0.7 microns, 0.4 microns to 0.6 microns, 0.4 microns to 0.5 microns, 0.4 microns to 1 micron, 0.5 microns to 1 micron, 0.6 microns to 1 micron, 0.7 microns to 1 microns, 0.8 microns to 1 micron, 0.5 microns to 0.9 microns, 0.6 microns to 0.9 microns, 0.7 microns to 0.9 microns, or 0.5 microns to 0.8 microns.

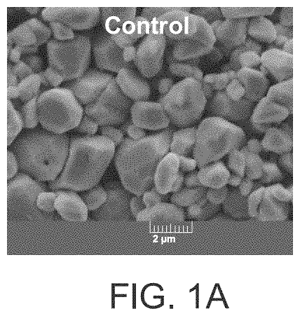

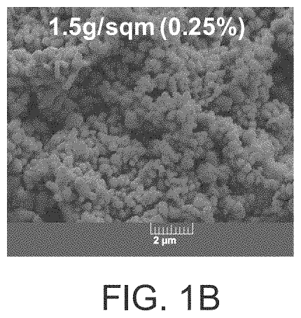

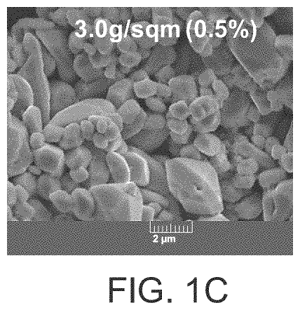

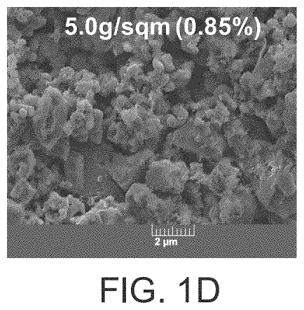

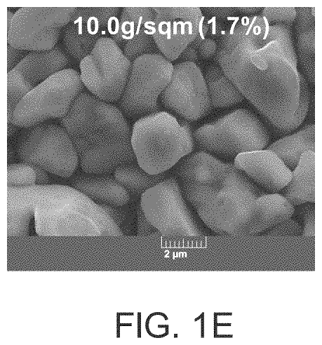

As previously described herein, during discharge cycles of a lead acid battery, lead sulfate (PbSO₄) crystals are produced on a surface of one or both of the anode and cathode electrodes (i.e. the “blank” or “control”). FIG. 1A is a scanning microscope (SEM) image of lead sulfate crystals produced on an electrode after 150 rounds of cycling, where the electrolyte used in the lead acid battery does not have a metal sulfate additive. FIG. 1B, FIG. 1C, FIG. 1D, and FIG. 1E are SEM images of lead sulfate crystals produced on an electrode after 150 rounds of cycling, where the electrolyte used in the lead acid battery has zinc sulfate added and/or released into the electrolyte in a concentration of 0.25%, 0.5%, 0.85%, and 1.7%, respectively. FIG. 1A, FIG. 1B, FIG. 1C, FIG. 1D, and FIG. 1E shows that addition of zinc sulfate results in smaller lead sulfate crystals compared to a control where a metal sulfate additive is not used. Table 1 describes an average size in one dimension of lead sulfate crystals formed at different original coating amounts (g/sqm) on a separator and concentrations in the electrolyte (%) of zinc sulfate. Some of the zinc sulfate coated on the separator ended up in the electrolyte in the amount (%) indicated in Table 1.

TABLE 1
Average Crystal Size for PbSO₄ in
the Presence of ZnSO₄ Additive.

| | |
|---|---|
| ZnSO₄ g/sqm | Avg. Crystal Size |
| (conc.) | (micron) |

| | | |
|---|---|---|
| 0 | (0) | 2.35 |
| 1.5 | (0.25%) | 0.89 |
| 3 | (0.5%) | 0.54 |
| 5 | (0.85%) | 1.07 |
| 10 | (1.7%) | 1.42 |

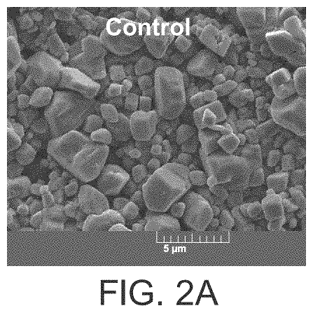

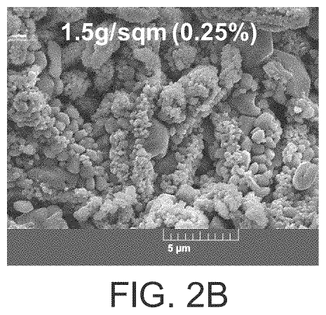

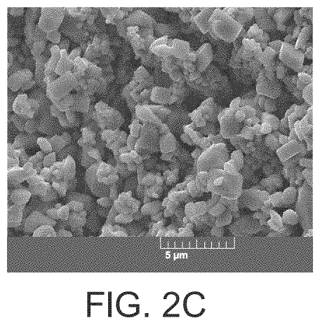

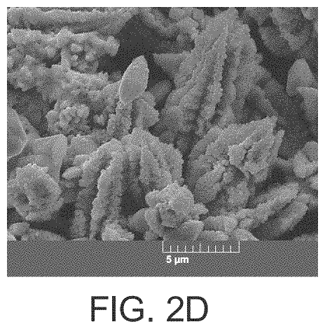

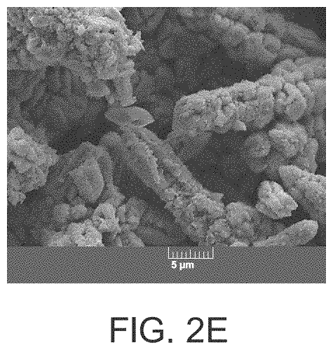

FIG. 2A is a scanning microscope (SEM) image of lead sulfate crystals produced on an electrode after 150 rounds of cycling, where the electrolyte used in the lead acid battery does not have a metal sulfate additive. FIG. 2B, FIG. 2C, FIG. 2D, and FIG. 2E are SEM images of lead sulfate crystals produced on an electrode after 150 rounds of cycling, where the electrolyte used in the lead acid battery has aluminum sulfate added in concentrations of 0.25%, 0.5%, 0.85%, and 1.7%, respectively. As shown in FIG. 2B, FIG. 2C, FIG. 2D, and FIG. 2E, an average size in one dimension of the lead sulfate crystals formed on the electrode surface is lower in the examples where aluminum sulfate is added compared to the control of FIG. 2A. However, it can be also seen by looking at FIG. 2B, FIG. 2C, FIG. 2D, and FIG. 2E that when amounts of aluminum sulfate at or above 0.85% are added to and/or released into the electrolyte, tree-branch-like or dendrite-like structures are formed. See FIG. 2D and FIG. 2E. These structures may be harmful to battery performance and thus are unfavorable. Thus, amounts less than 0.85% aluminum sulfate would be preferred because of the tree-branch-like or dendrite-like structures that are shown to grow at or above a 0.85% aluminum sulfate addition.

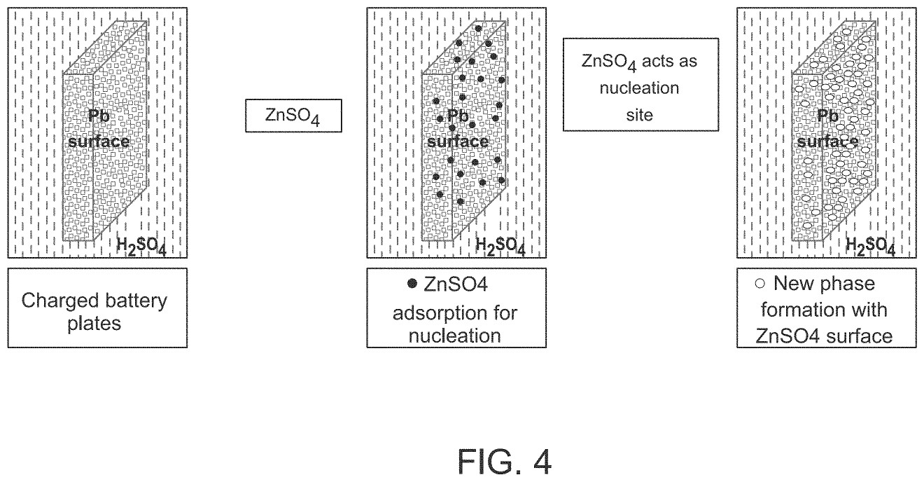

While not intending to be bound by theory, the metal sulfate is believed to act as a nucleating agent on the electrode surface and starts crystal growth of lead sulfate. As a result, fast lead sulfate crystal formation occurs, forming many small crystals during discharge of the battery. This concept is illustrated in FIG. 4 using zinc sulfate as an exemplary metal sulfate additive.

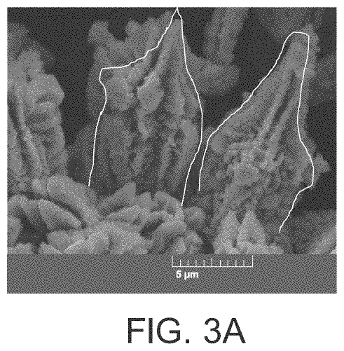

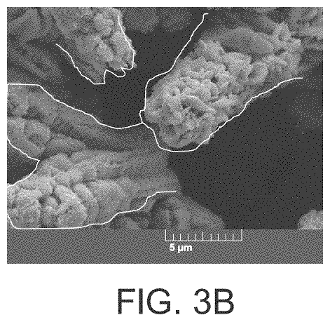

Unexpectedly, as the average size in one dimension decreases, the overall, quaternary shape of the lead sulfate crystals changes. For example, as described in Table 2 and shown in FIG. 1B, FIG. 1C, FIG. 2B, and FIG. 2C, when the zinc sulfate or aluminum sulfate is present in the electrolyte in a concentration of approximately 0.25% to 0.5%, tiny lead sulfate crystals are formed and serve as nucleation centers that control larger crystal formation and growth. As the concentration of the metal sulfate decreases below about 0.25% or increases above about 0.5%, as is also described in Table 2 and shown in FIG. 1B, FIG. 1C, FIG. 1D, and FIG. 1E and FIG. 2B, FIG. 2C, FIG. 2D, and FIG. 2E, the average individual crystal size begins to increase comparted to crystal sizes under metal sulfate concentrations of 0.25% to 0.5%, either through larger average crystal sizes and/or through formation of large quaternary structures or dendrite-like or tree-branch-like structures. While the average individual crystal size becomes smaller with increasing concentration—beneficially reducing peak current density of the battery—these small lead sulfate crystals can also promote lead sulfate growth in one direction (e.g. a Z-direction). This results in the formation tree-like quaternary structures of lead sulfate dendritic growth, which is especially noticeable in FIG. 2D and FIG. 2E at concentrations of at least 0.85% of metal sulfate. FIG. 3A and FIG. 3B are portions of the same SEM images as FIG. 2D and FIG. 2E, but the dendritic growth has been outlined to clearly highlight these tree-like quaternary structures. Such dendritic growth is believed to be undesirable, because the resulting sharp edges can puncture the separator, clog the pores of the separator, and potentially contact the other electrode to cause short-circuiting of the cell.

In some embodiments, a lead acid battery described herein comprising an electrolyte with a metal sulfate additive has a peak current density that is at least 20%, 25%, 30%, 35%, 40%, 45%, 50%, 55%, 60%, 65%, 70%, or 75% lower than a lead acid battery having an electrolyte without the metal sulfate additive present. Again, while not intending to be bound by theory, decreases in the average size in one dimension of the lead sulfate crystals is believed to be responsible for the lower peak current density effect of the metal sulfate in the electrolyte. For example, as shown in Table 2, the greatest peak current density reductions are shown for electrolytes with metal sulfate concentrations of 0.25% and 0.5% in the electrolyte. These two concentrations displayed the smallest average lead sulfate crystal sizes for the tested concentrations, as shown in Table 1.

TABLE 2
Peak Current Density and H₂ Gassing for ZnSO₄ additive.

| | | |
|---|---|---|
| ZnSO₄ | Peak Current Density | H₂ gassing |
| g/sqm (conc.) | Ip (A/cm2) | current at −1.4 V |

| | | | |
|---|---|---|---|
| 0 | (0) | 0.0064 | 0.0092 |
| 1.5 | (0.25%) | 0.0048 | 0.0016 |
| 3 | (0.5%) | 0.0043 | 0.0015 |
| 5 | (0.85%) | 0.0062 | 0.0049 |
| 10 | (1.7%) | 0.0061 | 0.0182 |

A surface area of the lead sulfate increases as the average size of the lead sulfate crystals decreases. Thus, during recharging, the aqueous sulfuric acid can contact more surface area of smaller lead sulfate crystals, leading to faster and more complete conversion back into the lead and lead oxide components forming the anode and cathode electrodes. Passive lead sulfate coatings on the electrode material is consequently reduced, meaning that more active electrode material is present. In contrast, since the average size in one dimension of the lead sulfate crystals in the control and at higher metal sulfate concentrations (e.g. lead sulfate dendrite formations) is larger, the respective surface area of the larger lead sulfate crystals is lower, so conversion back into the lead and lead oxide components during recharging is slower and the electrode does not always charge to completion. Any remaining unconverted lead sulfate crystals can then agglomerate and fuse together into highly insoluble deposits and sediments. Ultimately these unconverted lead sulfate crystals can form a passive sediment layer on the electrodes, reducing the amount of active material present and increasing peak current density of the battery. Additionally, the lead sulfate can flake off the electrodes to clog and block the pores of the separator, reducing ionic conductivity of the battery.

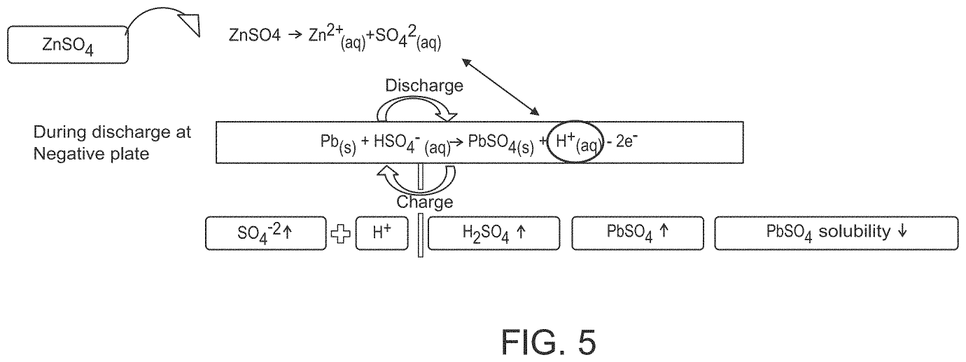

In some embodiments, a lead acid battery described herein comprising an electrolyte with a metal sulfate additive can have a hydrogen gassing current at −1.4V that is at least 50%, 60%, 70%, 80%, 90%, or 100% lower than a lead acid battery having an electrolyte without a metal sulfate additive present. Table 2 shows hydrogen gassing current at −1.4V as a function of metal sulfate concentration. As shown, there is a dramatic decrease in hydrogen gassing current at −1.4V when ZnSO₄ is present in the electrolyte in at least 0.25% to 0.5%. Again, while not intending to be bound by theory, decreases in the average size in one dimension of the lead sulfate crystals is believed to contribute to the reduction of hydrogen gassing current. For example, as shown in Table 2, the greatest hydrogen gassing current reductions are present when the metal sulfate has concentrations of 0.25% and 0.5% for the ranged tested. Additionally, as illustrated in FIG. 5, during discharge at the negative electrode, lead sulfate and hydrogen ions (e.g. H⁺) are normally produced. When a metal sulfate is added directly to and/or released into the electrolyte, SO₄²⁻ ion are thought to react with H⁺ ions to increase acid concentration and reduce H⁺ concentration. The reduction in H⁺ concentration appears to correspond to the reduction in hydrogen gas formation. With increasing ZnSO₄ addition, the acid specific gravity also increases as more SO₄²⁻ ions continue to react with more H⁺ ions. Increases in the acid specific gravity (which correlates to increased acid concentration), directly increases PbSO₄ solubility, leading to smaller PbSO₄ crystal formation, and more complete conversion of PbSO₄ back to lead and lead oxide during recharging. However, as indicated in FIG. 1A, FIG. 1B, FIG. 1C, FIG. 1D, FIG. E, FIG. 2A, FIG. 2B, FIG. 2C, FIG. 2D, and FIG. 2E, there is a metal sulfate concentration range in which a beneficial effect is optimal, with reducing benefits and increasing disadvantages as concentration increases or decreases away from this beneficial concentration range.

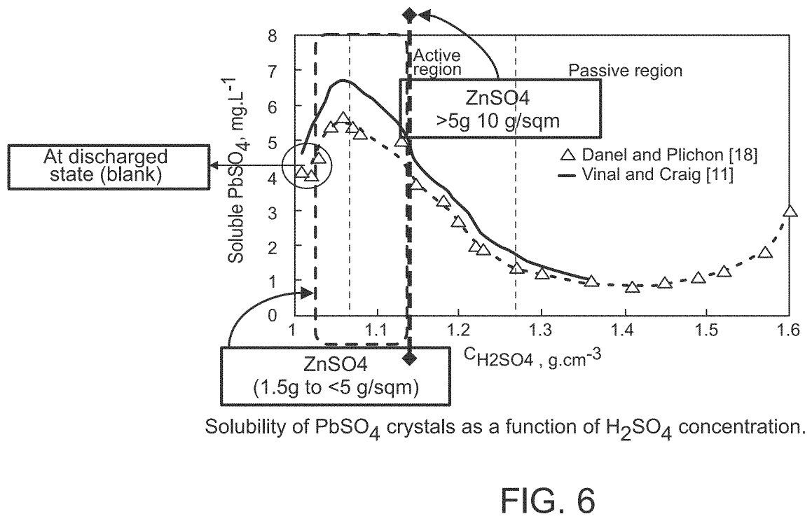

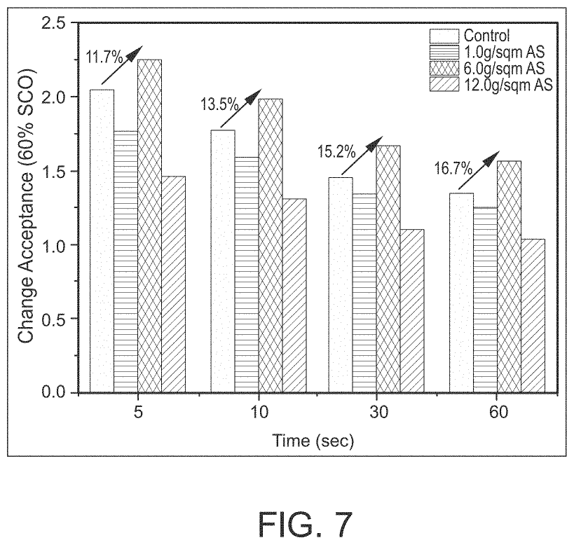

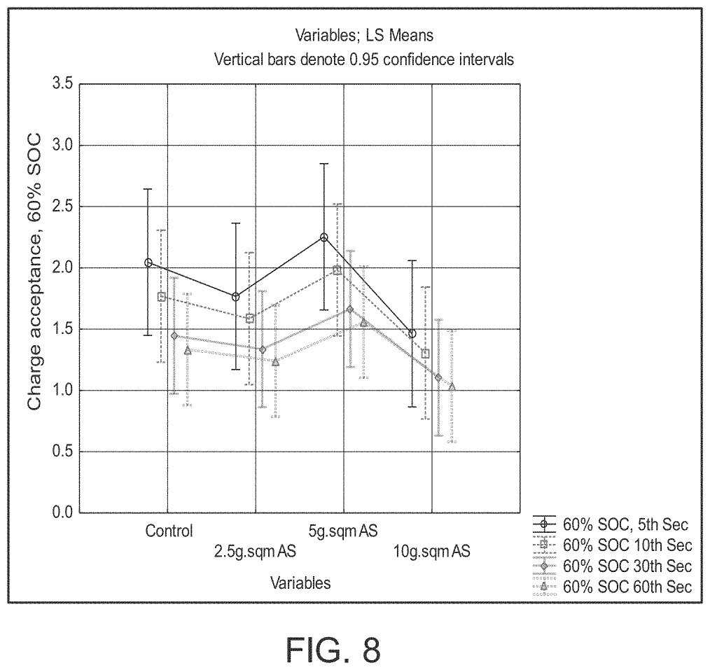

FIG. 6 graphically illustrates the increasing solubility of lead sulfate crystals as a function of increased acid concentration correlated with metal sulfate present in the electrolyte. As shown, lead sulfate is most soluble in the “active region, where sulfuric acid concentration is less than approximately 1:28 g/cc. Lead sulfate is least soluble in the passive region, where acid concentration is greater than approximately 1:28 g/cc. In the passive region, charge acceptance of the battery declines due to this low lead sulfate solubility, meaning the battery may not fully charge, which will shorten its cycle life because of lead sulfation on the electrode(s).

Accordingly, while a reduction in the size of lead sulfate crystals in a battery is desirable from a peak current density and hydrogen gassing perspective, there is an unexpected range in which the beneficial effects of this reduction are achieved. In some embodiments, these beneficial effects are achieved by a metal sulfate present in the electrolyte in a concentration of 1.3% or less, 1.2% or less, 1.1% or less, 1% or less, 0.95% or less, 0.9% or less, 0.85% or less, 0.8% or less, 0.75% or less, 0.7% or less, 0.65% or less, 0.6% or less, 0.55% or less, 0.5% or less, 0.45% or less, 0.4% or less, 0.35% or less, 0.3% or less, 0.25% or less, 0.2% or less, 0.15% or less, 0.1% or less, 0.09% or less, 0.08% or less, 0.07% or less, 0.06% or less, 0.05% or less, 0.04% or less, 0.03% or less, 0.02% or less, 0.01% or less, 0.01% to 1%, 0.05% to 1%, 0.1% to 1%, 0.2% to 1%, 0.25% to 1%, 0.3% to 1%, 0.35% to 1%, 0.4% to 1%, 0.45% to 1%, 0.5% to 1%, 0.55% to 1%, 0.6% to 1%, 0.65% to 1%, 0.01% to 0.75%, 0.01% to 0.65%, 0.01% to 0.6%, 0.01% to 0.55%, 0.01% to 0.5%, 0.01% to 0.45%, 0.01% to 0.4%, 0.01% to 0.35%, 0.01% to 0.3%, 0.01% to 0.25%, 0.01% to 0.2%, or 0.01% to 0.1%.

In some embodiments, a battery separator described herein comprises a metal sulfate. The metal sulfate can be any metal sulfate described herein or one that is not inconsistent with the objectives of this disclosure. The metal sulfate can in some instances be coated on a surface of the separator, and/or coated in some of the pores of the separator. When the coated separator is incorporated into a battery described herein, the metal sulfate dissolves in the electrolyte in beneficial concentrations previously described herein. Sometimes, less than 100% of the coated metal sulfate dissolves into the electrolyte, but sometimes almost 100% may dissolve. For example above 90% may dissolve, above 95% may dissolve, above 96% may dissolve, above 97% may dissolve, above 98% may dissolve, or above 99% may dissolve into the electrolyte. The metal sulfate can be roller coated, immersion coated, or spray coated on the separator.

In some embodiments, a metal sulfate is coated on a separator in an amount of 1 g/sqm to 4 g/sqm, 1.5 g/sqm to 4 g/sqm, 2 g/sqm to 4 g/sqm, 2.5 g/sqm to 4 g/sqm, 3 g/sqm to 4 g/sqm, 3.5 g/sqm to 4 g/sqm, 1 g/sqm to 3.5 g/sqm, 1 g/sqm to 3 g/sqm, 1 g/sqm to 2.5 g/sqm, 1 g/sqm to 2 g/sqm, 1 g/sqm to 1.5 g/sqm, 1.5 g/sqm to 3 g/sqm, 1.5 g/sqm to 2.5 g/sqm, 2 g/sqm to 3.0 g/sqm, 0.5 g/sqm, 0.75 g/sqm, 1 g/sqm, 1.25 g/sqm, 1.5 g/sqm, 1.75 g/sqm, 2 g/sqm, 2.25 g/sqm, 2.5 g/sqm, 2.75 g/sqm, 3 g/sqm, 3.25 g/sqm, 3.5 g/sqm, 3.75 g/sqm, 4 g/sqm, 4.25 g/sqm, 4.5 g/sqm, 4.75 g/sqm, 5 g/sqm, 5.25 g/sqm, 5.5 g/sqm, 5.75 g/sqm, 6 g/sqm, 6.25 g/sqm, 6.5 g/sqm, 6.75 g/sqm, or 7 g/sqm.

In some embodiments, a vehicle comprises a battery described herein comprising a metal sulfate additive.

### II. Methods

In another aspect, a method of reducing the size of lead sulfate crystals in a lead acid battery during cycling comprises adding a metal sulfate to an electrolyte solution in the lead acid battery, wherein lead sulfate crystals formed during cycling of the lead acid battery have an average diameter in one dimension of less than 1.1 microns, less than 1.0 microns, less than 0.95 microns, or less than 0.9 microns. The metal sulfate can be any metal sulfate, in any concentration, listed in Section I.

In yet another aspect, a method of reducing the size of lead sulfate crystals in a lead acid battery during cycling is described herein, comprising forming a battery separator comprising a metal sulfate; and placing the coated battery separator into a lead acid battery, wherein the lead sulfate crystals formed during cycling of the lead acid battery have an average diameter in one dimension less than 1.1 microns, less than 1.0 microns, less than 0.95 microns, or less than 0.9 microns. As described in Section I, the metal sulfate can be coated within pores of the separator, on a surface of the separator, or both within the pores and on the surface of the separator. Furthermore, in some embodiments, coating the metal sulfate comprises roller coating, curtain coating, immersion coating, or spray coating the metal sulfate on the separator. A slurry or solution comprising one or more metal sulfates may be coated using the aforementioned methods or other suitable methods. After application, the coating may be dried. Drying may include any suitable method including application of heat, air, light, or a combination thereof.

As described in Section I, lead sulfate crystals formed during cycling of the lead acid battery according to methods described in this section can have an average diameter in one dimension that is at least 50%, 60%, 70%, 80%, 90%, or at least 100% smaller than lead sulfate crystals formed during cycling of a lead acid battery without a metal sulfate present.

In some further embodiments, the one or more metal sulfates described herein may be in the mixture used to form the battery separator, e.g., a mixture comprising polyolefin, filler, and processing oil. In such embodiments, the one or more metal sulfates may be added as a powder. In such embodiments, the metal sulfate ends up in the matrix of the separator.

Various embodiments in this disclosure have been described in fulfillment of the various objectives of the invention. It should be recognized that these embodiments are merely illustrative of the principles disclosed. Numerous modifications and adaptations thereof will be readily apparent to those skilled in the art without departing from the spirit and scope of the invention.

1-43. (canceled)

44. A lead acid battery comprising:
a positive electrode;
a negative electrode;
a separator; and
an electrolyte comprising a metal sulfate;
wherein lead sulfate crystals formed after 150 rounds of cycling of the lead acid battery have an average diameter in one dimension of less than 1.1 microns, less than 1.0 microns, less than 0.95 microns, or less than 0.9 microns.

45. The lead acid battery of claim 44, wherein the metal sulfate consists essentially of at least one selected from the group consisting of aluminum sulfate, zinc sulfate, potassium sulfate, sodium sulfate, lithium sulfate, magnesium sulfate, barium sulfate, nickel sulfate, or combinations thereof.

46. The lead acid battery of claim 1, wherein lead sulfate crystals formed during cycling of the lead acid battery have an average diameter in one dimension of 0.4 microns to 0.9 microns.

47. The lead acid battery of claim 44, wherein peak current density is at least 20% lower than a lead acid battery having an electrolyte without a metal sulfate present.

48. The lead acid battery of claim 44, wherein hydrogen gassing current at −1.4V is at least 70% lower than a lead acid battery having an electrolyte without a metal sulfate present.

49. The lead acid battery of claim 44, wherein at least one of the separator, a glass mat, a woven, a nonwoven, a gauntlet, a pasting paper, the positive electrode, the negative electrode, or combinations thereof comprises metal sulfate.

50. The lead acid battery of claim 44, wherein metal sulfate is coated on at least one of the separator, a glass mat, a woven, a nonwoven, a gauntlet, a pasting paper, the positive electrode, and the negative electrode, or combinations thereof.

51. The lead acid battery of claim 50, wherein the metal sulfate is present in an amount of 1 g/sqm to 4.0 g/sqm.

52. The lead acid battery of claim 50, wherein the metal sulfate is roller coated, immersion coated, or spray coated.

53. The lead acid battery of claim 44, wherein the separator is made of a microporous material.

54. The lead acid battery of claim 44, wherein the metal sulfate is present in the electrolyte in a concentration of 1% or less.

55. The lead acid battery of claim 45, wherein the metal sulfate comprises zinc sulfate.

56. The lead acid battery of claim 45, wherein the metal sulfate comprises aluminum sulfate and no or less than five tree-branch-like or dendrite-like structures grow during cycling.

57. The lead acid battery of claim 45, herein the metal sulfate comprises potassium sulfate.

58. A vehicle comprising a battery according to claim 1.

59. A method of reducing the size of lead sulfate crystals in a lead acid battery during cycling, comprising:
adding a metal sulfate to and/or releasing a metal sulfate into an electrolyte solution in the lead acid battery, wherein lead sulfate crystals formed after 150 rounds of cycling of the lead acid battery have an average diameter in one dimension less than 1.1 microns, less than 1.0 microns, less than 0.95 microns, or less than 0.9 microns.

60. The method of claim 59, wherein the metal sulfate consists essentially of aluminum sulfate, zinc sulfate, potassium sulfate, sodium sulfate, lithium sulfate, magnesium sulfate, barium sulfate, nickel sulfate, or combinations thereof.

61. The method of claim 59, wherein lead sulfate crystals formed during cycling of the lead acid battery have an average diameter in one dimension that is at least 60% smaller than lead sulfate crystals formed during cycling of a lead acid battery without a metal sulfate present.

62. The method of claim 59, wherein the electrolyte solution comprises a concentration of 1% or less of metal sulfate.

63. The method of claim 60, wherein the metal sulfate comprises zinc sulfate.

64. The method of claim 60, wherein the metal sulfate comprises aluminum sulfate and no or less than five tree-branch-like or dendrite-like structures form during cycling.

65. The method of claim 60, wherein the metal sulfate comprises potassium sulfate.

66. A method of reducing the size of lead sulfate crystals in a lead acid battery during cycling, comprising:
placing a battery separator comprising a metal sulfate into a lead acid battery, wherein the lead sulfate crystals formed after 150 rounds of cycling of the lead acid battery have an average diameter in one dimension less than 1.1 microns, less than 1.0 microns, less than 0.95 microns, or less than 0.9 microns.

67. The method of claim 66, wherein the metal sulfate is coated within pores on a surface of the separator, on a surface of the separator, or both; or the metal sulfate is on an exposed or internal surface of a pasting paper, a woven, a nonwoven, a gauntlet, an electrode, or a glass mat; or the metal sulfate is present within the matrix of the battery separator, e.g., it was included in the mixture extruded to form the battery separator.

68. The method of claim 67, wherein coating the metal sulfate comprises roller coating, immersion coating, curtain coating, or spray coating of a solution or slurry comprising the metal sulfate on the separator, the woven, the nonwoven, the gauntlet, the glass mat, the electrode, or the pasting paper.

69. The method of claim 66, wherein the metal sulfate consists essentially of aluminum sulfate, zinc sulfate, potassium sulfate, sodium sulfate, lithium sulfate, magnesium sulfate, barium sulfate, nickel sulfate, or combinations thereof.

70. The method of claim 66, wherein lead sulfate crystals formed during cycling of the lead acid battery have an average diameter in one dimension that is at least 60% smaller than lead sulfate crystals formed during cycling of a lead acid battery without a metal sulfate present.

71. The method of claim 69, wherein the metal sulfate comprises zinc sulfate.

72. The method of claim 69, wherein the metal sulfate comprises aluminum sulfate and no or less than five tree-branch-like or dendrite-like structures form during cycling.

73. The method of claim 69, wherein the metal sulfate comprises potassium sulfate.

74. A battery separator, glass mat, woven nonwoven, gauntlet, pasting paper, or electrode comprising a metal sulfate.

75. The battery separator, glass mat, woven, nonwoven, gauntlet, pasting paper, or electrode of claim 74, wherein the metal sulfate is present in an amount of 1 g/sqm to 4.0 g/sqm or in an amount sufficient to release an appropriate amount of metal sulfate into the electrolyte when the battery separator, glass mat, woven, nonwoven, gauntlet, pasting paper, electrode, or combinations thereof are used in a battery.

76. The battery separator, glass mat, woven, nonwoven, gauntlet, pasting paper, or electrode of claim 75, wherein a solution or slurry comprising the metal sulfate is roller coated, immersion coated, curtain coated, or spray coated onto the battery separator, glass mat, woven, nonwoven, gauntlet, pasting paper, or electrode.

77. The battery separator, glass mat, woven, nonwoven, gauntlet, pasting paper, or electrode of claim 74, wherein the metal sulfate is at least one selected from aluminum sulfate, zinc sulfate, potassium sulfate, sodium sulfate, lithium sulfate, magnesium sulfate, barium sulfate, nickel sulfate, or combinations thereof.

78. The battery of claim 44, wherein the separator comprises an acid-mixing rib profile.

79. The battery separator of claim 74, comprising an acid-mixing rib profile.

80. The method of claim 66, wherein the separator comprise an acid-mixing rib profile.

81. A battery separator comprising coating comprising aluminum sulfate in an amount of greater than about 1 gram per square meter (gsm) and less than about 12 gsm.

82. The battery separator of claim 81, wherein the coating weight is greater than about 3 gsm and less than about 10 gsm.

83. The battery separator of claim 81, wherein the coating weight is greater than about 5 gsm and less than about 8 gsm.

84. The battery separator of claim 81, wherein the coating weight is 6 gsm.

85. The battery separator of claim 81, wherein the battery separator exhibits improved charge acceptance (60% SOC) over time.

86. The battery separator of claim 83, wherein the improvement is at least 5% compared to a control separator without aluminum sulfate.

87. The battery separator of claim 84, wherein the improvement is at least 10%.

88. The battery separator, glass mat, woven, nonwoven, gauntlet, pasting paper, or electrode of claim 75, wherein the battery separator comprises a metal sulfate in the matrix, e.g., the metal sulfate was added to a mixture extruded to form the battery separator.

89. A vehicle comprising a battery according to claim 45.

90. A vehicle comprising a battery according to claim 50.
